(19) United States
(12) Patent Application Publication
(10) Pub. No.: US 2006/0209561 A1
(43) Pub. Date: Sep. 21, 2006

(54) Light-emitting device and apparatus having the same

(76) Inventor: Yoshiharu Tenmyo, Kanagawa-ken (JP)

Correspondence Address: COWAN LIEBOWITZ & LATMAN P.C.;JOHN J TORRENTE, 1133 AVE OF THE AMERICAS, NEW YORK, NY, 10036, US

(21) Appl. No.: 11/369,101

(22) Filed: Mar. 6, 2006

(30) Foreign Application Priority Data
Mar. 18, 2005 (JP) 2005-079496(PAT.)

(51) Int. Cl. F21V 7/04

(52) U.S. Cl. 362/602

(57) ABSTRACT

A light-emitting device is disclosed which can be realized as a single device and can change luminous fluxes from a plurality of light sources having different uses and different characteristics into luminous fluxes having predetermined light-emitting characteristics without changing the mounting position in an apparatus. The light-emitting device has a first light guiding portion which receives first light from a first light source, a second light guiding portion which receives second light from a second light source, and an optical member which includes an emergence portion from which the light emerges after it passes each of the light guiding portions.

### BACKGROUND OF THE INVENTION

The present invention relates to a light-emitting device for use in various apparatuses such as image-taking apparatuses including a video camera and a digital still camera, and camera-equipped cellular phones, and particularly, to a light-emitting device having a ring-shaped light emergence portion disposed around an image-taking lens, by way of example.

Some of image-taking apparatuses such as a video camera and a digital still camera have a capability to take an image of an-object at an extremely close range from an image-taking lens (a macro photography capability).

In such macro photography, the use of a typical illumination apparatus (a light-emitting device) provided for a camera, for example at an upper portion thereof, causes disadvantages such as a failure to illuminate uniformly a necessary irradiation area resulting from part of the illumination light being blocked by a lens barrel, and an unnatural image including a dark shadow on one side of an object.

To address this, various patent applications as described below have proposed illumination apparatuses and image-taking apparatuses in which a ring-shaped light emergence portion or a plurality of light emergence portions are disposed around the end of a lens barrel to allow illumination suitable for the macro photography.

Japanese Patent Laid-Open No. 2000-314908 has proposed an illumination apparatus in which light from a flash unit for normal image-taking is directed to the periphery of a lens barrel by using a plurality of optical fibers.

Japanese Patent Laid-Open No. 8(1996)-43887 has proposed an image-taking apparatus in which optical paths are switched when a flash unit emits light to perform image-taking with flashlight and when light from the flash unit is directed to a light guide having an emergence surface disposed around a lens barrel.

Japanese Patent Laid-Open No. 2001-255574 has proposed an external illumination apparatus which has a ring-shaped portion for mounting on the outer periphery of a lens barrel to guide illumination light from a light source in the circumferential direction of the ring-shaped portion before emergence.

Many of recent video cameras include both a light source (for example, an LED or a lamp) which emits continuous light over a long time period for taking moving images and a light source (for example, a xenon discharge tube) which emits flashlight for taking still images. It is highly desirable to provide an illumination apparatus which changes illumination luminous fluxes from both of the light sources into illumination luminous flux appropriate for macro photography.

In all the illumination apparatuses and the image-taking apparatuses proposed in the abovementioned patent applications, however, light from the single light source or the light source having the single characteristic is merely directed to the ring-shaped light emergence portion. To achieve illumination suitable for each of the macro photography of moving images and the macro photography of still images, it is necessary that two illumination apparatuses with different light sources are provided or that different entrance portions of light to be directed to the ring-shaped emergence portion are provided in accordance with the positions of the two light sources (that is, the mounting position of the illumination apparatus must be changed).

### BRIEF SUMMARY OF THE INVENTION

It is an object of the present invention to provide a light-emitting device which can be realized as a single device and can change luminous fluxes from a plurality of light sources having different uses or different characteristics into luminous fluxes having predetermined light-emitting characteristics (for example, light distribution characteristics) without changing the mounting position in an apparatus, and the apparatus having the light-emitting device.

According to one aspect, the present invention provides a light-emitting device having a first light guiding portion which receives first light from a first light source, a second light guiding portion which receives second light from a second light source, and an optical member which includes an emergence portion from which the light emerges after it passes each of the first and second light guiding portions.

According to another aspect, the present invention provides an apparatus on which the above-mentioned light-emitting device is removably mounted and an apparatus which has the above-mentioned light-emitting device integrally therewith.

Other objects and features of the present invention will become readily apparent from the following description of the preferred embodiments with reference to accompanying drawings.

### BRIEF DESCRIPTION OF THE DRAWINGS

FIG. 1 is a front view of a video camera on which a ring light adapter for macro photography which is Embodiment 1 of the present invention is mounted.

FIG. 2 is a front view of the ring light adapter for macro photography of Embodiment 1.

FIG. 3 is a section view of an optical member forming part of the ring light adapter for macro photography of Embodiment 1.

FIG. 4 is a section view of the optical member forming part of the ring light adapter for macro photography of Embodiment 1.

FIG. 5 is a section view of the ring light adapter developed in a circumferential direction.

FIG. 6 is a section view for explaining a luminous flux mainly emitted from a flashlight emitter in an optical system of the ring light adapter for macro photography of Embodiment 1.

FIG. 7 is a section view of the ring light adapter developed in the circumferential direction.

FIG. 8 is a section view for explaining a luminous flux mainly emitted from a continuous light emitter in the optical system of the ring light adapter for macro photography of Embodiment 1.

FIG. 9 is a perspective view showing the video camera and the ring light adapter of Embodiment 1 separately.

FIG. 10 is a perspective view showing the video camera on which the ring light adapter for macro photography of Embodiment 1 is mounted.

FIG. 11 is a front view of a ring light adapter for macro photography which is Embodiment 2 of the present invention.

FIG. 12 is a section view of an optical member forming part of the ring light adapter for macro photography of Embodiment 2.

FIG. 13 is a section view of the optical member forming part of the ring light adapter for macro photography of Embodiment 2.

FIG. 14 is a front view of a ring light adapter for macro photography which is Embodiment 3 of the present invention.

FIG. 15 is a section view of an optical member forming part of the ring light adapter for macro photography of Embodiment 3.

FIG. 16 is a section view of the optical member forming part of the ring light adapter for macro photography of Embodiment 3.

FIG. 17 is a front view of a ring light adapter for macro photography which is Embodiment 4 of the present invention.

FIG. 18 is a section view of an optical member forming part of the ring light adapter for macro photography of Embodiment 4.

FIG. 19 is a section view of the optical member forming part of the ring light adapter for macro photography of Embodiment 4.

### DETAILED DESCRIPTION OF THE PREFERRED EMBODIMENTS

Preferred embodiments of the present invention will hereinafter be described with reference to the drawings.

(Embodiment 1)

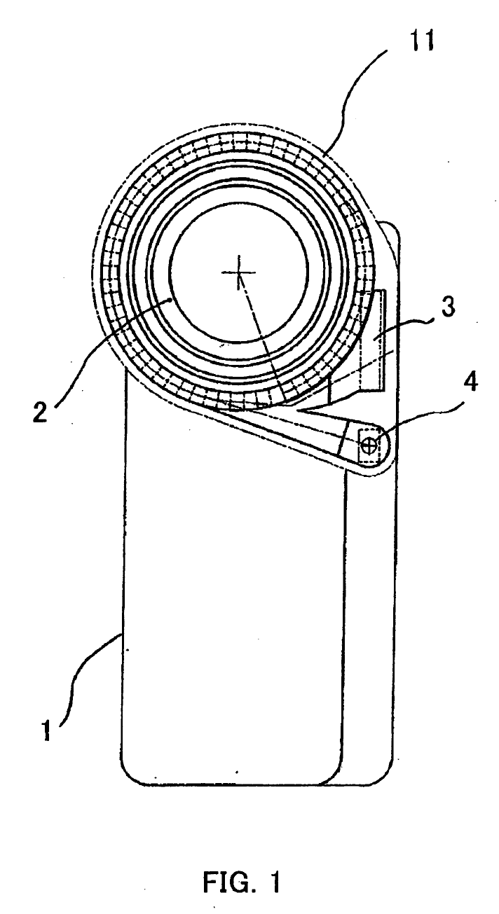

FIGS. 1 to 10 show a light-emitting device which is Embodiment 1 of the present invention, and specifically, a ring light adapter for macro photography which can be mounted on an image-taking apparatus such as a video camera.

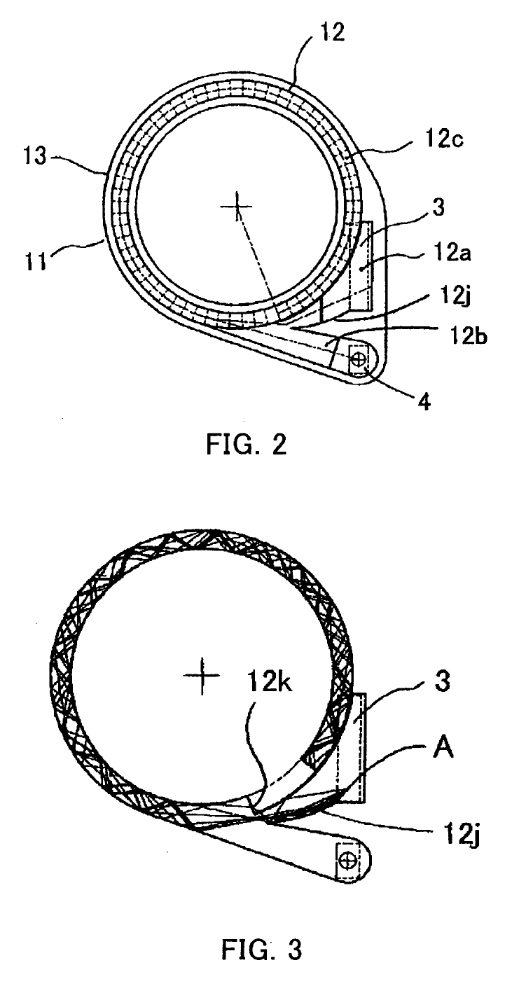

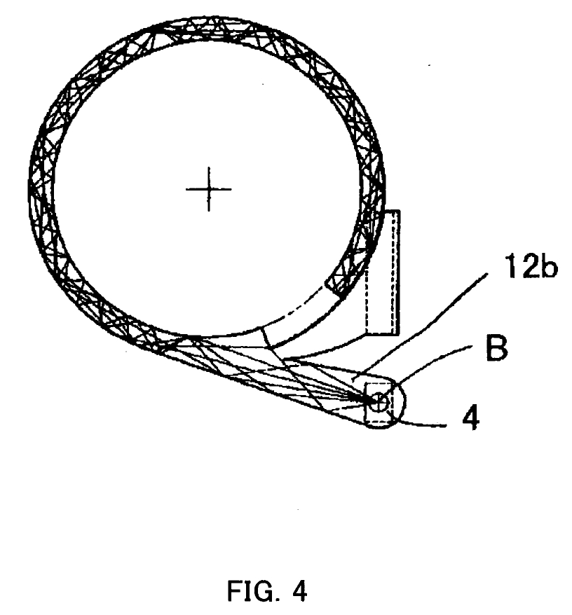

FIG. 1 is a front view of a video camera on which the ring light adapter is mounted. FIG. 2 is a front view of the ring light adapter. FIGS. 3 and 4 are section views of an optical member forming part of the ring light adapter and also show light ray tracing diagrams of light rays emitted from representative points of light sources.

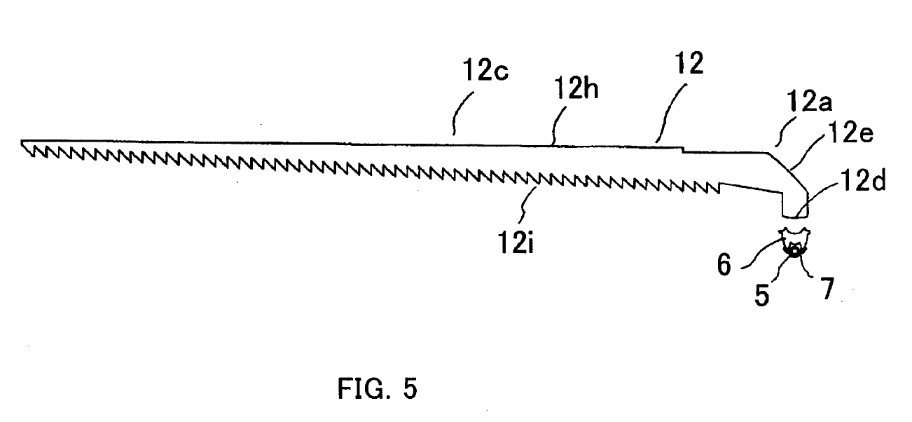

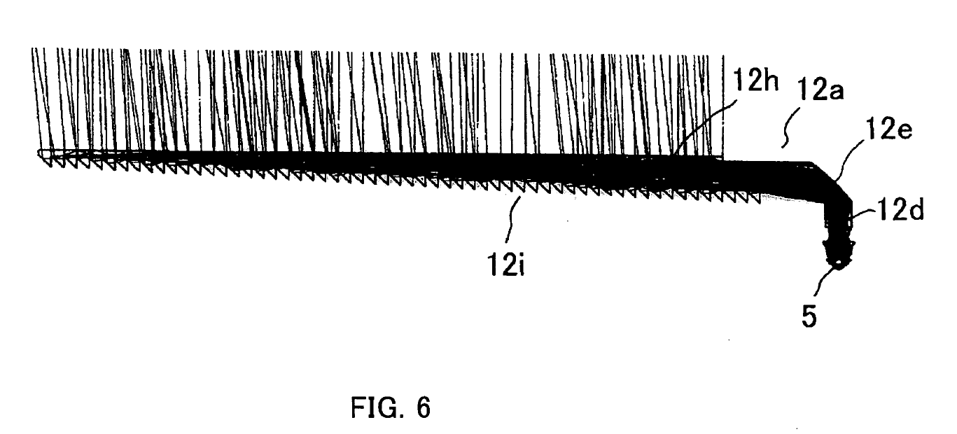

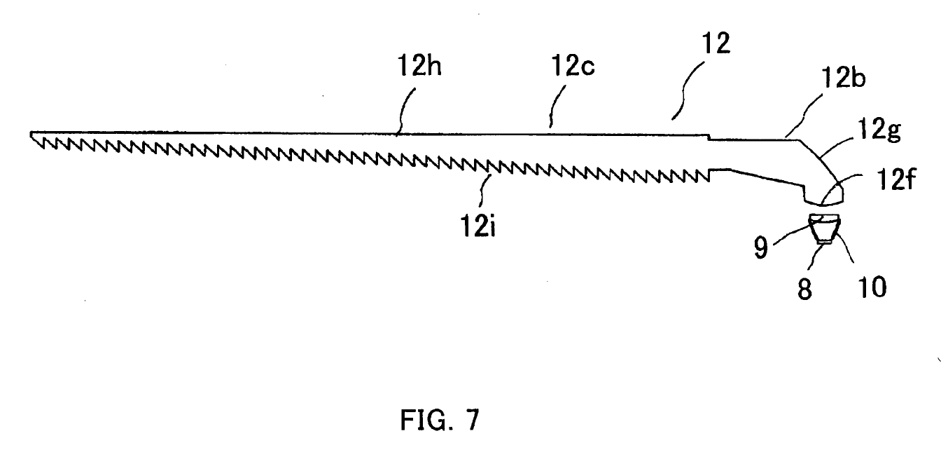

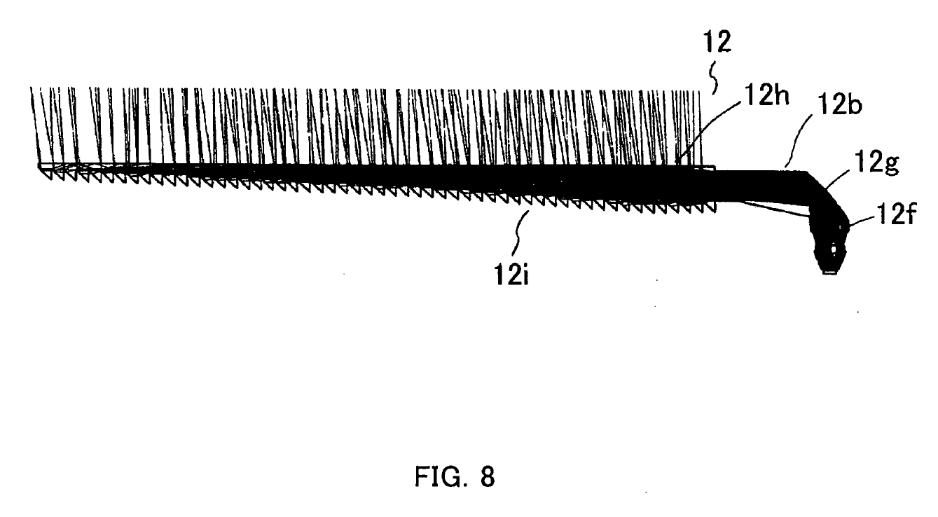

FIGS. 5 to 8 are section views of a ring portion (an emergence portion) of the optical member forming part of the ring light adapter, developed in a circumferential direction. Specifically, FIGS. 5 and 6 are section views for explaining a luminous flux which is mainly emitted from a flashlight source in an optical system of the ring light adapter. FIG. 6 shows a light ray tracing diagram of representative light rays emitted from the light source, added to the section view shown in FIG. 5. FIGS. 7 and 8 are section views for explaining a luminous flux which is mainly emitted from a continuous light source in the optical system of the ring light adapter. FIG. 8 shows a light ray tracing diagram of representative light rays emitted from the light source, added to the section view shown in FIG. 7.

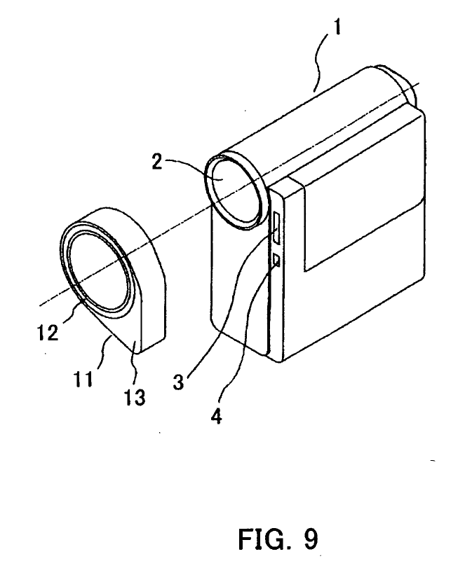

FIG. 9 is a perspective view showing the video camera and the ring light adapter of Embodiment 1 separately. FIG. 10 is a perspective view showing the video camera on which the ring light adapter of Embodiment 1 is mounted.

As shown in FIGS. 1, 9, and 10, the ring light adapter for macro photography of Embodiment 1 is removably mounted around the end of an image-taking lens barrel in the video camera. When the adapter is mounted, it can change luminous fluxes emitted from both of a flashlight emitter and an LED emitter provided for a video camera body into ring-shaped luminous flux (hereinafter referred to as ring light).

In FIGS. 1, 9, and 10, reference numeral 1 shows the video camera body, 2 the image-taking lens barrel, and 3 the flashlight emitter of light from a light source such as a xenon discharge tube. Reference numeral 4 shows the LED light emitter of light from a light source such as a white LED.

Reference numeral 11 shows a macro ring light adapter body, 12 an optical member, and 13 a holding member for holding the optical member 12.

Next, description will be made of components which provide optical characteristics of the macro ring light adapter 11 in more detail with reference to FIGS. 2 to 8.

In FIG. 5, reference numeral 5 shows a xenon discharge tube (hereinafter referred to as an arc tube) which emits flashlight (also referred to as a spark of light or instantaneous light). Reference numeral 6 shows a condenser prism which is disposed closer to a light irradiation side than the arc tube 5 and condenses a luminous flux emitted from the arc tube 5. Reference numeral 7 shows a reflecting member which is disposed across the arc tube 5 from the light irradiation side and reflects a luminous flux emitted from the arc tube 5 toward the light irradiation side. The abovementioned components constitute the flashlight emitter 3.

In FIG. 7, reference numeral 8 shows a high-luminance white LED which can emit a uniform luminous flux as continuous light (fixed light) toward the light irradiation side for a longer time period than by the arc tube 5. Reference numeral 9 shows a condenser lens which condenses the luminous flux emitted from the white LED 8 and is formed of a resin material with high light transmission. Reference numeral 10 shows a reflecting member which gathers part of luminous flux emitted from the white LED 8 that emerges at a relatively large angle with respect to an irradiation optical axis. The abovementioned components constitute the LED light emitter 4. All the members designated with the reference numerals 5 to 10 are contained in the video camera body 1.

Next, the structure of the ring light adapter 11 will be described. The optical member 12 responsible for changing the luminous fluxes emitted from the flashlight emitter 3 and the LED light emitter 4 into ring light is formed of a light-transmissive resin material, for example, an optical resin material with high light transmission and excellent moldability such as an acrylic resin and a polycarbonate resin. The optical member 12 is held by the holding member 13 shown in FIGS. 2, 9, and 10. An entrance surface of the optical member 12 is positioned and held at the front of the condenser prism 6 and the condenser lens 9 provided for the video camera body 1.

As shown in FIGS. 2, 5, and 7, the optical member 12 is broadly formed of three portions: a flashlight guiding portion 12a which changes the direction of the luminous flux emitted from the arc tube 5 and condensed by the condenser prism 6 and guides the luminous flux in the changed direction to a ring portion 12c, later described; an LED light guiding portion 12b which changes the direction of the luminous flux from the white LED 8 and condensed by the condenser lens 9 and guides the luminous flux in the changed direction to the ring portion 12c; and the ring portion 12c which serves as the emergence portion common to the flashlight and continuous light and changes the luminous fluxes directed thereto by the light guiding portions 12a and 12b into ring-shaped luminous flux generally in parallel with the optical axis direction of the image-taking lens before emergence. The light guiding portions 12a and 12b are provided outside the ring portion 12c in the diameter direction. The flashlight emitter 3 and the LED light emitter 4 are disposed behind entrance surfaces 12d and 12f (closer to an image plane) of the light guiding portions 12a and 12b, respectively.

In the video camera body 1, when an image-taking mode is set to a super night mode, that is, when a mode of illumination is set for using a high-luminance LED in dark environments with poor outside light and fill light required, the white LED 8 emits light. This mode typically assumes a camera-to-object distance of 50 cm or longer, and the mode does not require the ring light adapter 11. However, many types of video cameras are capable of macro photography, and for example, not a few video cameras can take images at a close range up to approximately 1 cm. When macro photography is attempted with illumination only from one side of an object by using a typical light source which can be regarded as almost one point, the following problem occurs.

Specifically, in this case, the image-taking lens barrel interferes with the illumination light to darken part of the image extremely.

When the ring light adapter 11 of Embodiment 1 is used, however, uniform illumination can be applied to an object from various directions to prevent an unnatural shadow by the lens barrel. In other words, illumination light from the given almost one point can be changed into ideal illumination light and applied as ring light from a large emergence surface close to a surface light source without any strong shadow or unnatural shadow.

On the other hand, in recent years, more and more video cameras have been provided with a light source of flashlight (a spark of light) for taking still images in addition to the white LED which emits continuous light for taking moving images. Under the circumstances, the ring light adapter 11 for macro photography desirably supports not only a continuous light source such as the white LED but also a flashlight source. The ring light adapter 11 of Embodiment 1 allows illumination luminous fluxes from both of the continuous light source and the flashlight source to emerge from the same ring-shaped emergence surface.

FIGS. 5 and 7 show section views for explaining the shape of the optical member 12 from the light guiding portions 12a, 12b to the ring portion 12c. The ring portions 12c in the FIGS. 5 and 7 represent the same member. FIGS. 6 and 8 also show the light ray tracing diagrams of representative light rays in the optical member 12.

As shown in FIG. 6, a luminous flux emitted from the arc tube 5 is then gathered to a predetermined irradiation angle range by the optical effects of the condenser prism 6 and the reflecting member 7. In the same manner, aluminous flux emitted from the white LED 8 is then gathered to a predetermined irradiation angle range by the optical effects of the condenser lens 9 and the reflecting member 10. The predetermined irradiation angle ranges refer to irradiation angle ranges necessary for a typical camera-to-object distance (for example, 50 cm or longer) in the video camera. The shapes of the respective optical members and the positional relationship between them and the light sources are adjusted to satisfy the irradiation angle range.

The luminous fluxes are emitted from the respective light sources in this manner and are sent to the light guiding portions 12a and 12b which then change their directions and change their condensing states as appropriate for forming the ring light. This will hereinafter be described in detail.

The entrance surfaces 12d and 12f of the light guiding portions 12a and 12b are somewhat larger than the openings of the condenser prism 6 and the condenser lens 9 and are disposed close to the condenser prism 6 and the condenser lens 9 provided for the video camera body 1, respectively. These structures are necessary for taking in the luminous fluxes emitted from the condenser prism 6 and the condenser lens 9 as much as possible, and that arrangement enables the most effective use of the light amounts emitted from the light sources.

Next, the luminous fluxes entering the light guiding portions 12a and 12b from the entrance surfaces 12d and 12f are then totally reflected by total reflection surfaces 12e and 12g formed on the light guiding portions 12a and 12b, respectively, thereby changing their directions approximately 90 degrees to efficiently guide them to the ring portion 12c. The direction change is realized basically by the total reflection without using a metal-evaporated surface with high reflectivity which is often used as a reflecting surface, so that the optical system can be provided with extremely high efficiency. The total reflection is a phenomenon in which a component of luminous flux traveling from a medium with a high refractive index to a medium with a low refractive index that has an angle larger than a critical angle at the boundary between them is reflected with a reflectivity of 100%.

In Embodiment 1, the total reflection surfaces 12e and 12g made as continuous aspheric surfaces are formed in the light guiding portions 12a and 12b to change the directions efficiently as shown in the light ray tracing diagrams of FIGS. 6 and 8. The elements of the optical system after the total reflection surfaces 12e and 12g are also based on the use of the total reflection to guide the luminous flux. This can direct the luminous flux at lower cost with higher efficiency as compared with the use of the typical reflecting surface realized by a metal-evaporated surface. However, the entire luminous flux may not be reflected through the total reflection depending on the condensing degree of the luminous flux or the refractive index of the optical member, so that it is possible to reduce loss of the luminous flux by disposing other reflecting surfaces outside the total reflection surfaces 12e and 12g or performing metal evaporation on portions of the total reflection surfaces 12e and 12g.

Next, description will be made of the structure for changing the directions of the luminous flux which reached the ring portion 12c to a direction generally in parallel with the optical axis of the image-taking lens (a direction toward an object).

In Embodiment 1, the optical member 12 has a section (hereinafter referred to as a row of prisms) 12i, which includes micro prisms arranged in the circumferential direction, formed at the position opposite to an emergence surface 12h to redirect the luminous flux guided to the ring portion 12c toward the object.

Specifically, the angle of a reflecting surface forming part of each prism of the prism row 12i (hereinafter referred to as a prism reflecting surface) is set to be inclined approximately 40 degrees with respect to the emergence surface 12h.

FIGS. 6 and 8 show the ring portion 12c developed in the circumferential direction to explain how the luminous fluxes, which were emitted from the arc tube 5 and the white LED 8 and reached the ring portion 12c of the optical member 12, emerge from the emergence surface 12h of the optical member 12 in Embodiment 1.

The prism row 12i includes a plurality of micro prism reflecting surfaces continuously over substantially the entire circumference of the ring portion 12c such that only the component of the luminous flux directed to the ring portion 12c that travels in a predetermined angle range is reflected toward the emergence surface 12h. All the prism reflecting surfaces are formed to be opposite diagonally to the same direction, that is, the traveling direction of the luminous flux. The traveling of the luminous flux guided to the ring portion 12c is regulated in one direction, and the all the prism reflecting surfaces are inclined on the same side, thereby making it possible to totally reflect only the luminous flux component in the predetermined angle range.

In addition, the remaining luminous flux can be once refracted to emerge outside the optical member 12 and again enter the optical member 12 from a prism edge surface formed between the prism reflecting surface which that luminous flux passed and the adjacent prism reflecting surface in the traveling direction.

This will be described in more detail. The component of the luminous flux incident on the prism reflecting surface and then totally reflected thereby that has an angle smaller than a critical angle with respect to the emergence surface 12h is transmitted through the emergence surface 12h for emergence. On the other hand, the component of the luminous flux totally reflected by the prism reflecting surface that has an angle larger than the critical angle with respect to the emergence surface 12h is totally reflected by the emergence surface 12h and returned toward the prism row 12i. The component of the luminous flux incident on the prism reflecting surface that has an angle smaller than a critical angle with respect to the prism reflecting surface is then transmitted through the prism reflecting surface and emerges outside the optical member 12. At this point, the component is refracted by the prism reflecting surface and thus enters again the optical member 12 from the prism edge surface present in the traveling direction of the luminous flux. The series of the reflections and refractions is repeated until the luminous flux is changed to have an angle at which it can emerge from the emergence surface 12h after the total reflection by the prism reflecting surface. Finally, the entire luminous flux emerges from the emergence surface 12h to achieve effective use of the luminous flux from the light sources.

In Embodiment 1, the ring portion 12c is formed such that its thickness is at the maximum at the portion connected to the light guiding portions 12a and 12b (the thickness in the direction orthogonal to the emergence surface 12h) and the thickness is gradually reduced toward the end in the traveling direction of the luminous flux. Thus, almost the entire the luminous flux which entered the ring portion 12c can be changed to components in a predetermined angle range during the traveling over the entire circumference of the ring portion 12c to achieve the emergence thereof from the emergence surface 12h.

As a result, a luminous flux emerging outside the necessary irradiation area is basically not present, and the highly efficient light-emitting device can be formed. In addition, the luminous flux which passed the prism reflecting surface or the prism edge surface emerges with a substantially uniform light amount from substantially the entire emergence surface 12h regardless of the different positions on the reflecting surface and the different number of refractions.

Conventionally, in the typical illumination optical system called a surface light-emitting type, the surface of an optical member opposite to an emergence surface is formed as a diffusing surface realized by a white color dot print pattern or the like. The luminous flux is diffused as required by the diffusing surface and emerges from the optical member, and then is reflected by a reflecting plate, returned toward the emergence surface, and caused to emerge from the emergence surface. The luminous flux is once subjected to the diffusion effect for the direction change in this manner, resulting in significant loss of light amount.

In Embodiment 1, since the direction of the luminous flux is changed by the total reflection effect in the optical member 12 as described above, the direction change is accomplished with high efficiency. Specifically, the luminous flux at an angle unsuitable for emergence from the emergence surface 12h is refracted by taking advantage of not satisfying the total reflection condition, while only the luminous flux satisfying the condition for emergence from the emergence surface 12h is caused to emerge. This allows the luminous flux once excluded for not satisfying the condition to be used later effectively with the help of the subsequent element of the optical system. Thus, the provided light energy can be effectively utilized with almost no waste.

In Embodiment 1, the luminous fluxes emitted from the respective light sources are then subjected to the lens effects of the condenser prism 6 disposed opposite to the emergence surface of the arc tube 5 and the entrance surface 12d of the optical member 12 as shown in FIG. 5 and the lens effects of the condenser lens 9 disposed opposite to the emergence surface of the white LED 8 and the entrance surface 12f of the optical member 12 as shown in FIG. 7, respectively. The resulting luminous flux has angles within a predetermined range with respect to the circumferential direction of the ring portion 12c (the traveling direction of the luminous flux). Thus, only a small part of the luminous flux is not totally reflected by the total reflection surface 12e and 12g and escapes outside the optical member 12, and the luminous flux entering the ring portion 12c also has angles within a predetermined range with respect to the light traveling direction. Since the angles of the luminous flux fall within the predetermined range in this manner, the ring portion 12c can send light highly efficiently with a uniform light amount from the entire circumference thereof.

The luminous flux does not travel exactly perpendicular to the emergence surface 12h and is slightly inclined with respect to the perpendicular direction (that is, its emergence optical axis is inclined). The inclination presents a problem in a typical illumination apparatus. In the ring light adapter, however, the emergence portion is ring-shaped, and when each luminous flux component has a substantially unchanged emergence direction, they act to complement each other. Even when the optical axis of emergence is inclined to some degree, the ring can provide uniform illumination as a whole.

Next, description will be made of the most characteristic point of the present invention, that is, how the luminous fluxes from the plurality of light sources are guided to the single ring portion 12c through the light guiding portions 12a, 12b and how the light loss is minimized at the connection between the light guiding portions 12a, 12b and the ring portion 12c, with reference to FIGS. 2 to 4.

FIGS. 2 to 4 are section views showing the connections between the light guiding portions 12a, 12b and the ring portion 12c, and the luminous flux directed to the ring portion 12c.

As described above, the optical member 12 of Embodiment 1 is formed of the two light guiding portions 12a, 12b and the single ring portion 12c. Efficiently guiding the luminous fluxes in the connecting area of the light guiding portions 12a, 12b and the ring portion 12c is extremely important in forming the macro ring adapter 11 which supports the two light sources.

It is difficult for the light guiding portion of flashlight (hereinafter referred to as the flashlight guiding portion) 12a to use effectively the entire luminous flux since the flashlight emitter 3 which is the light source therefor is in close proximity to the ring portion 12c and the luminous flux emerges from the flashlight emitter 3 in a considerably wide range of directions. In Embodiment 1, the shapes of the respective portions are specified so as to effectively use part of the luminous flux from the flashlight emitter 3 that mainly emerges from a lower portion in FIGS. 2 to 4 (a portion farthest from the ring portion 12c).

The entrance surface 12d (FIG. 5) of the light guiding portion 12a is maximized to have substantially the same size as the opening of the flashlight emitter 3 to take in the luminous flux as much as possible. The shape of a lower reflecting surface 12j shown in FIG. 2 is optimized to totally reflect part of the luminous flux from the flashlight emitter 3 to direct the luminous flux toward the ring portion 12c. For the position of the connection between the light guiding portion 12a and the ring portion 12c, the portion shown by a dashed line extending from the center of the optical axis corresponds to the joint between the thickest portion and the thinnest portion of the ring portion 12c described above (they may be in contact with or may be only close to each other) in FIG. 2, and the light guiding portion 12a is connected to the ring portion 12c in an area which includes that point.

As seen from the light ray tracing diagram of light rays emerging from a representative point A in FIG. 3, the total reflection by the reflecting surface 12j directs the luminous flux to the ring portion 12c. As shown in FIG. 2, part of the light guiding portion 12a near the connection to the ring portion 12c has a narrower width and thus the luminous flux easily escapes from the light guiding portion 12a. However, such part of the luminous flux which once escaped outside the light guiding portion 12a can enter the ring portion 12c from an end surface 12k produced by a difference in height between the thickest portion and the thinnest portion at the joint thereof in the ring portion 12c and is used effectively.

On the other hand, the luminous flux emitted from the LED light emitter 4 disposed at the position relatively away from the ring portion 12c can be directed relatively efficiently to the ring portion 12c since the light source is relatively small. Specifically, as shown in FIG. 4, the light guiding portion 12b has a rather uniform width and can guide the luminous flux emitted from the light source toward the ring portion 12c with almost no waste. In this case, the connection between the light guiding portion 12b and the ring portion 12c is provided in an area adjacent to the joint between the thickest portion and the thinnest portion in the ring portion 12c.

In this manner, to efficiently direct the luminous fluxes emitted from the two light sources (the light emitters 3 and 4) to the ring portion 12c, the light guiding portions are connected from the same direction to the ring portion 12c near the joint between the thickest portion and the thinnest portion thereof (in the area including the joint or the area adjacent to the joint) while the light guiding portions are in contact with the ring portion. Such connection is effective in improving the efficiency of light use. That connection also allows the luminous fluxes from both of the light sources to emerge from the entire emergence surface 12h of the same ring portion 12c with substantially uniform light amounts.

While Embodiment 1 has been described in conjunction with the ring light adapter removably mounted on the image-taking apparatus, a ring light adapter having the same structure may be provided integrally with (built in) the image-taking apparatus. This applies to Embodiments 2 to 4, later described.

(Embodiment 2)

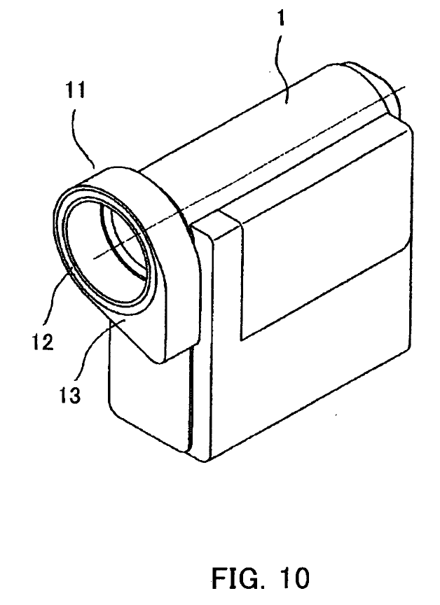

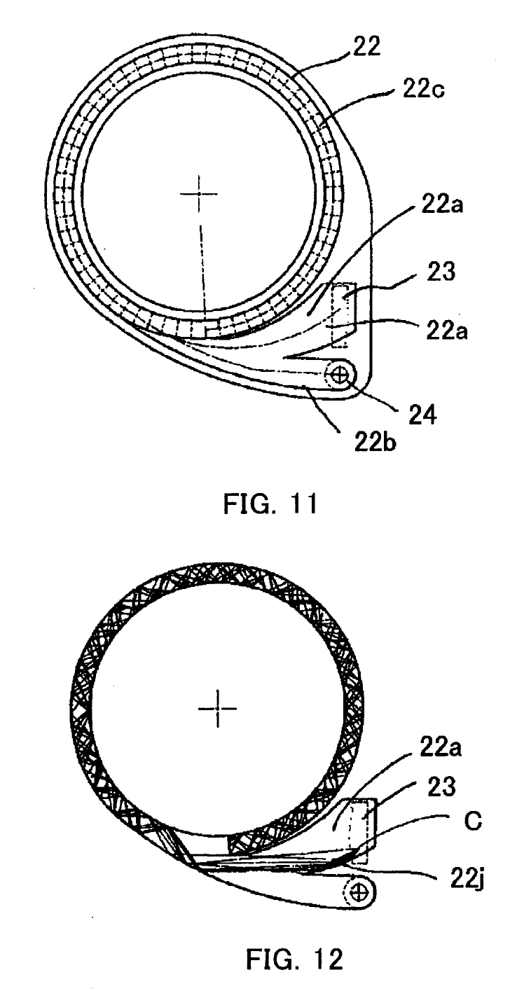

FIGS. 11 to 13 show a ring light adapter for macro photography which is Embodiment 2 of the present invention. Since Embodiment 2 is a modification of Embodiment 1, description will mainly focus on differences from Embodiment 1, and the description of the same components and arrangements as in Embodiment 1 is omitted.

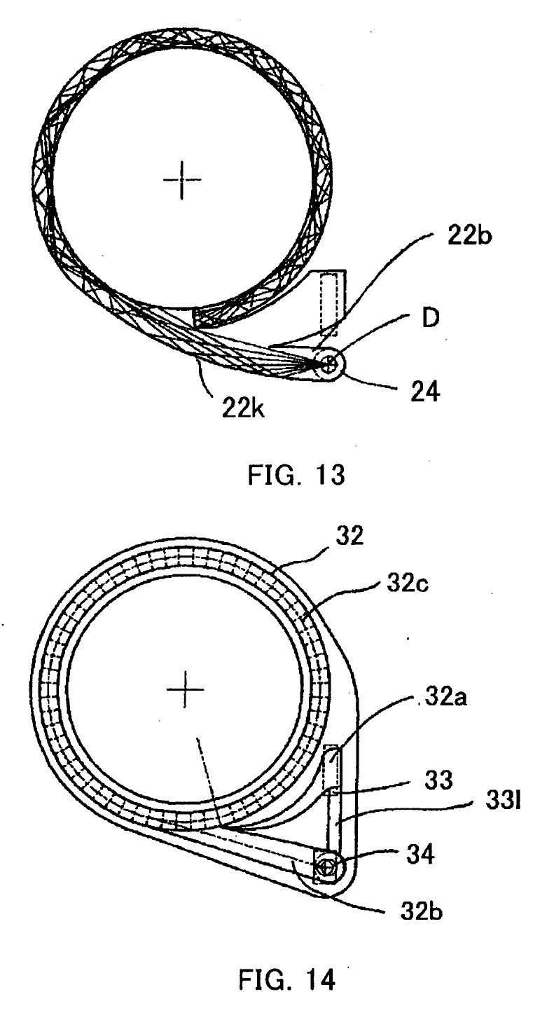

FIG. 11 is a front view of the ring light adapter of Embodiment 2. FIGS. 12 and 13 are section views of an optical member forming part of the ring light adapter, and also show light ray tracing diagrams of light rays emerging from representative points C and D of respective light sources.

Embodiment 2 differs from Embodiment 1 in how two light guiding portions 22a and 22b are connected to a ring portion 22c. Specifically, in Embodiment 2, the two light guiding portions 22a and 22b are connected to each other in an optical member 22, and then they are connected to the ring portion 22c. The flashlight guiding portion 22a is used to direct a luminous flux from a flashlight emitter 23 to the ring portion 22c, while the LED light guiding portion 22b is used to direct a luminous flux from an LED light emitter 24 to the ring portion 22c.

Such connection is effective when the two light sources are present at positions relatively close to each other and away from the ring portion 22c. It is convenient since the two light sources can be handled substantially as one light source, not as the two independent light sources. In addition, they can be connected with the minimized connecting width to the ring portion 22c, and the luminous flux can be uniformed within the light guiding portions 22a and 22b to enable emergence of uniform illumination light from the entire ring portion 22c.

The flashlight emitter 23 of Embodiment 2 is smaller than that in Embodiment 1, and is located at a lower position. The two light emitters 23 and 24 are closer to each other than in Embodiment 1, so that the luminous fluxes from the two light sources are easily combined. Since they are relatively far from the ring portion 22c, the combined luminous fluxes are conveniently mixed to provide uniform irradiation. In addition, the ring portion 22c may be connected only to the light guiding portion 22b, so that the connection is easily realized.

Similarly to Embodiment 1, the optical member 22 of Embodiment 2 is broadly formed of the two light guiding portions 22a, 22b and the single ring portion 22c. The light guiding portion 22a for flashlight can use the luminous flux emitted from the flashlight emitter 23 relatively effectively since the flashlight emitter 23 is relatively away from the ring portion 22c and the flashlight emitter 23 is smaller than that in Embodiment 1. In Embodiment 2, similarly to Embodiment 1, the shapes of respective portions are specified so as to effectively use part of the luminous flux from the flashlight emitter 23 that mainly emerges from a lower portion.

An entrance surface of the light guiding portion 22a is maximized to have substantially the same size as the opening of the flashlight emitter 23 to take in the luminous flux as much as possible. As shown in FIG. 12, the shape of a lower reflecting surface 22j is optimized to totally reflect part of the luminous flux emitted from the flashlight emitter 23 to guide the luminous flux in a predetermined direction.

For the LED light guiding portion 22b which directs the luminous flux emitted from the LED light emitter 24 placed below the flashlight emitter 23 toward the ring portion 22c, similarly to Embodiment 1, it can direct the light emitted from the light source relatively efficiently since the light source is relatively small. The luminous flux can be reflected mainly by a reflecting surface 22k on the outer side of the LED light guiding portion 22b and directed to the ring portion 22c.

In this manner, in Embodiment 2, since the two light guiding portions 22a and 22b are connected to each other at the position relatively close to the light sources, the luminous fluxes from both of the light sources can be mixed uniformly and then directed to the ring portion 22c. As the light sources are closer to each other and the light sources are farther from the ring portion 22c, the luminous fluxes are easily mixed uniformly.

As shown in FIG. 11, the portion shown by a dashed line drawn from the center of the optical axis corresponds to the joint between the thickest portion and the thinnest portion of the ring portion 22c. The flash guiding portion 22a is connected to the ring portion 22c in an area including that position.

FIG. 12 is a light ray tracing diagram of light rays emerging from the representative point C to show how the luminous flux is totally reflected by the reflecting surface 22j and directed to the ring portion 22c. FIG. 13 is a light ray tracing diagram of light rays emerging from the representative point D to show how the luminous flux is totally reflected by the reflecting surface 22k on the outer side of the light guiding portion 22b and directed to the ring portion 22c.

To direct the luminous fluxes emitted from the two light sources relatively away from the ring portion 22c and relatively close to each other efficiently toward the ring portion 22c, it is effective in terms of efficiency of light use to once combine the luminous fluxes emitted from the respective light sources (that is, both of the light guiding portions 22a and 22b are connected to each other), and to connect the LED light guiding portion 22b to the ring portion 22c in the area (or the area adjacent thereto) including the joint between the thickest portion and the thinnest portion of the ring portion 22c. When this arrangement is employed, the luminous flux from each of the light sources can emerge from the entire ring portion 22c with a substantially uniform light amount.

While Embodiment 2 has been described in conjunction with the ring portion relatively away from the light sources, the structure of Embodiment 2 is more effective as the ring portion is farther away from the light sources and as the light sources are closer to each other.

(Embodiment 3)

FIGS. 14 to 16 show a ring light adapter for macro photography which is Embodiment 3 of the present invention. Since Embodiment 3 is a modification of Embodiment 1, description will mainly focus on differences from Embodiment 1, and the description of the same components and arrangement as in Embodiment 1 is omitted.

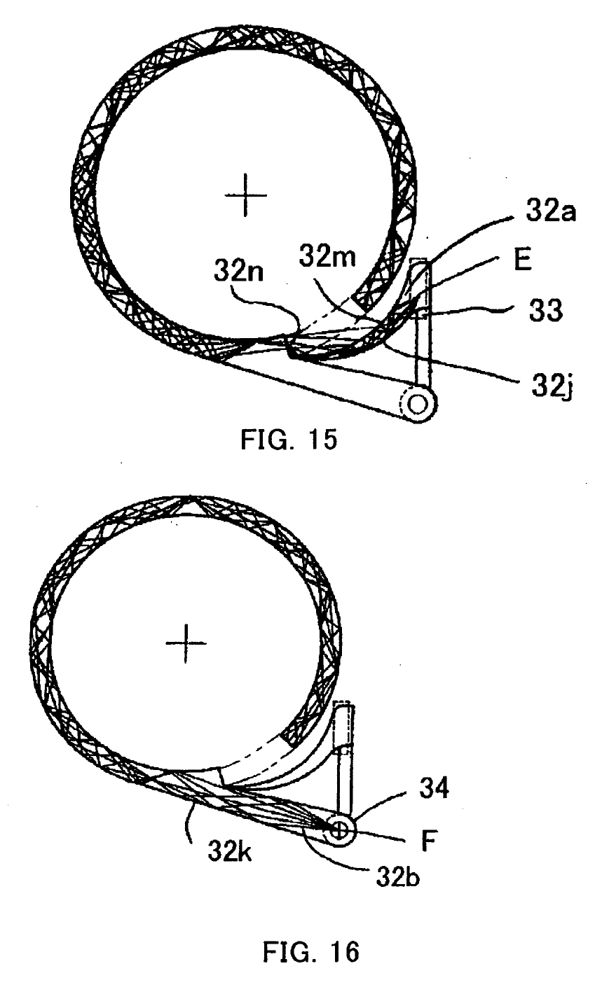

FIG. 14 is a front view of the ring light adapter for macro photography of Embodiment 3. FIGS. 15 and 16 are section views of an optical member forming part of the ring light adapter for macro photography, and also show light ray tracing diagrams of light rays emerging from representative points E and F of respective light sources.

Embodiment 3 differs from Embodiment 1 in how two light guiding portions 32a and 32b are connected to a ring portion 32c. Specifically, in Embodiment 3, the flashlight guiding portion 32a is not directly connected to the ring portion 32c. A luminous flux from a flashlight emitter 33 is once caused to emerge outside an optical member 32 and then enters the optical member 32 from an end surface 32n produced in the junction between the thickest portion and the thinner portion of the ring portion 32c. In other words, in Embodiment 3, the optical path which is used in a secondary manner in Embodiment 1 is utilized primarily.

In FIGS. 14 to 16, the optical member 32 formed of a light-transmissive transparent resin material has a shape which is partially different from that of the optical member 12 in Embodiment 1. Reference numeral 34 shows an LED light emitter.

Similarly to Embodiment 1, the optical member 32 of Embodiment 3 is broadly formed of the two light guiding portions 32a and 32b and the single ring portion 32c. In Embodiment 3, similar to Embodiment 1, the shapes of respective portions are specified so as to effectively use part of the luminous flux emitted from the flashlight emitter 33 that emerges mainly from a lower portion in FIGS. 14 to 16. However, the shape of the flashlight guiding portion 32a in Embodiment 3 greatly differs from that in Embodiment 1 .

An entrance surface of the flashlight guiding portion 32a is maximized to have substantially the same size as the opening of the flashlight emitter 33 to take in the luminous flux as much as possible. The flashlight guiding portion 32a is shaped such that its thickness is at the maximum closest to the light source and is gradually reduced toward the ring portion 32c. The inner surface and the outer surface of the flashlight guiding portion 32a are formed of curved surfaces along the curved surfaces of the ring portion 32c.

The outer surface of the flashlight guiding portion 32a is formed of a metal-evaporated surface with high reflectivity to prevent almost the entire luminous flux from emerging away from the flashlight guiding portion 32a. In addition, the flashlight guiding portion 32a has a thin end portion which is not directly connected to the ring portion 32c, and has a mechanical connection 331 for integration with the optical member 32.

On the other hand, the LED light guiding portion 32b is connected to the ring portion 32c in contact with an area (or an area adjacent thereto) of the ring portion 32c including a step portion (or different level portion) with the maximum difference in thickness (the joint), similarly to Embodiment 1. The LED light guiding portion 32b has a nearly uniform thickness, so that it leaks only a small amount of light outside, and its shape is effective for uniforming the luminous flux in the light guiding portion 32b.

Description will be made of the luminous fluxes from both of the light sources in the optical member 32 formed as described above with reference to FIGS. 15 and 16.

As shown in FIG. 15, part of the luminous flux from the flashlight emitter 33 is then directed toward the ring portion 32c by the flashlight guiding portion 32a. Since the flashlight guiding portion 32a has the thickness gradually reduced away from the light source and the outer surface realized by the reflecting surface, the entire luminous flux entering the flashlight guiding portion 32a then emerges from a surface 32m on the inner side along the curved surface. The luminous flux emerging from the flashlight guiding portion 32a then enters the ring portion 32c from the end surface 32n produced by the difference in thickness of the ring portion 32c. On the other hand, as shown in FIG. 16, the luminous flux from the LED light emitter 34 is directed by the LED light guiding portion 32b. The portion shown by a dashed line drawn from the center of the optical axis in FIG. 14 corresponds to the joint of the thickest portion and the thinnest portion of the ring portion 32c (the step portion), and the LED light guiding portion 32b is connected to the ring portion 32c in the area including the connecting point (or the area adjacent thereto).

In this manner, the light guiding portion 32a is not necessarily connected directly to the ring portion in order to direct the luminous flux to the ring portion 32c. It is possible that the luminous flux once emerges outside the optical member 32 and then enters it from the end surface (the entrance surface) 32n of the ring portion 32c. The flashlight and the continuous light entering the ring portion 32c then emerges from an emergence surface of the same ring portion 32c.

While Embodiment 3 has been described in conjunction with the metal-evaporated surface with high reflectivity used as the surface on the outer side of the flashlight guiding portion 32a, the present invention is not limited thereto. For example, a highly reflective member may be disposed immediately outside the light guiding portion 32a to reflect the luminous flux.

(Embodiment 4)

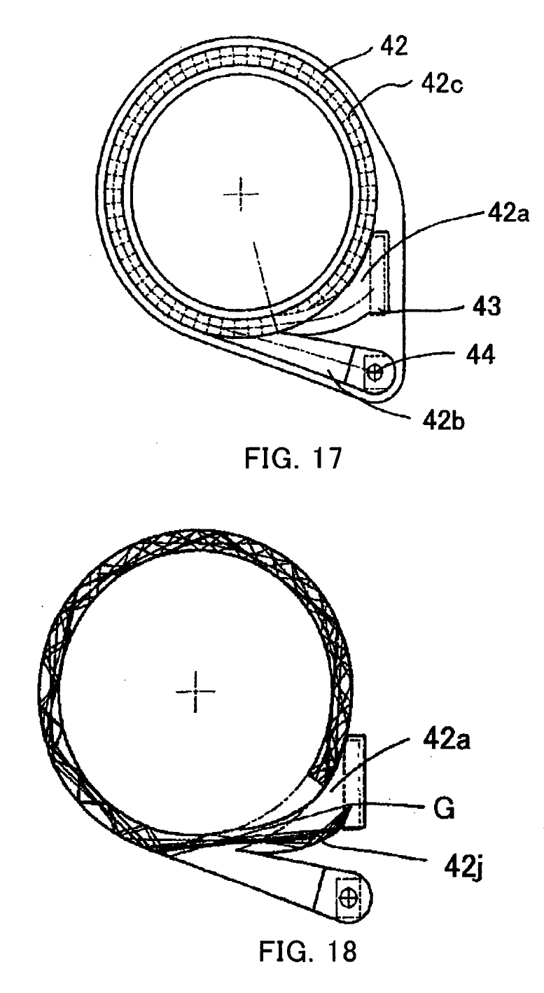

FIGS. 17 to 19 show a ring light adapter for macro photography which is Embodiment 4 of the present invention. Since Embodiment 4 is a modification of Embodiment 1, description will mainly focus on differences from Embodiment 1, and the description of the same components and arrangements as in Embodiment 1 is omitted.

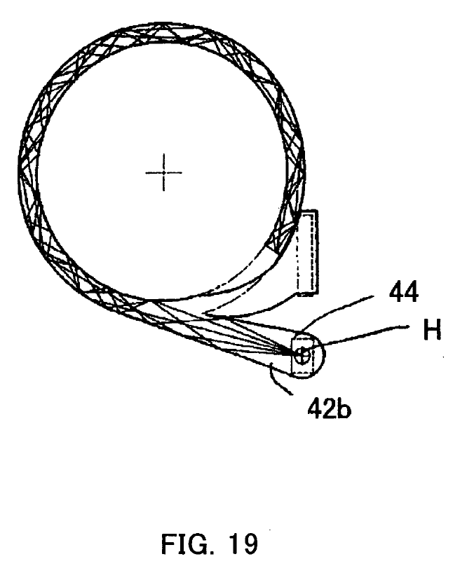

FIG. 17 is a front view of the ring light adapter for macro photography of Embodiment 3. FIGS. 18 and 19 are section views of an optical member forming part of ring light adapter for macro photography, and also show light ray tracing diagrams of light rays emerging from representative points G and H of respective light sources.

Embodiment 4 differs from Embodiment 1 in how two light guiding portions 42a and 42b are connected to a ring portion 42c. Specifically, in Embodiment 4, the flashlight guiding portion 42a is directly connected to an end surface produced at the joint between the thickest portion and the thinnest portion of the ring portion 42c (a step portion).

In FIGS. 17 to 19, the optical member 42 made of a light-transmissive transparent resin material has a shape which is partially different from that in Embodiment 1. Reference numeral 43 shows a flashlight emitter and 44 an LED light emitter.

Similarly to Embodiment 1, the optical member 42 of Embodiment 4 is broadly formed of the two light guiding portions 42a, 42b and the single ring portion 42c. In Embodiment 4, similarly to Embodiment 1, the shapes of respective portions are specified so as to effectively use part of the luminous flux from the flashlight emitter 43 that mainly emerges from a lower portion. However, the shape of the flashlight guiding portion 42a is different from that in Embodiment 1.

An entrance surface of the flashlight guiding portion 42a is maximized to have substantially the same size as the opening of the flashlight emitter 43 to take in the luminous flux as much as possible. The shape thereof is formed such that the luminous flux taken in on the light source side is guided directly to the step portion of the ring portion 42c.

The luminous flux preferably enters the ring portion 42c in the direction of a tangent to the ring portion 42c. However, when luminous fluxes from a plurality of light sources are caused to enter it, the light guiding portion for the light from the light source is increased in length, and it is difficult to apply light from the entire circumference of the ring portion 42c in some light sources. Thus, in Embodiment 4, the luminous flux from one end of the flashlight guiding portion 42a closer to the light source is caused to enter directly the end surface in the step portion at the joint between the thickest portion and the thinnest portion of the ring portion 42c to allow light emission from the entire circumference of the ring portion 42c even when the plurality of light sources are used.

On the other hand, the LED light guiding portion 42b is connected to the step portion with the maximum thickness difference in the ring portion 42c, similarly to Embodiment 1. The LED light guiding portion 42b has a nearly uniform thickness, so that it leaks only a small amount of light outside, and its shape is effective for uniforming the luminous flux in the light guiding portion 42b.

Description will be made of the luminous fluxes from the respective light sources in the optical member 42 formed as described above with reference to FIGS. 18 and 19.

As shown in FIG. 18, part of the luminous flux emitted from the flashlight emitter 43 is then guided toward the ring portion 42c by the flashlight guiding portion 42a. Since the flashlight guiding portion 42a is directly connected to the end surface produced by the thickest portion and the thinnest portion of the ring portion 42c, it can efficiently guide the luminous flux to the ring portion 42c as shown in the light ray tracing diagram of FIG. 18.

On the other hand, as shown in FIG. 19, the luminous flux emitted from the LED light emitter 44 is then guided toward the ring portion 42c by the LED light guiding portion 42b. The portion shown by a dashed line extending from the center of the optical axis in FIG. 17 corresponds to the joint between the thickest portion and the thinnest portion of the ring portion 42c, and the light guiding portion 42b is connected to an area including that joint (or an area adjacent thereto).

In this manner, the luminous flux from the one end of the flashlight guiding portion 42a closer to the light source is caused to enter directly the end surface produced by the thickest portion and the thinnest portion of the ring portion 42c, which also enables emission of the light with a substantially uniform light amount from the entire ring portion 42c when the plurality of light sources are used.

Embodiment 4 has been described in conjunction with the flashlight guiding portion 42a connected to the end surface produced by the thickest portion and the thinnest portion of the ring portion 42c over the entire width of the end surface. However, it is not necessarily connected thereto over the entire width, and it may be connected to part of the end surface. This allows formation of a row of prisms (see the row of prisms 12i in Embodiment 1) over the entire circumference of the ring portion 42c, so that the luminous flux can emerge from the entire ring portion 42c.

In addition, the flashlight guiding portion 42a may not be connected to the end surface of the ring portion 42c over the entire thickness thereof, and it may be connected to part of the end surface.

While Embodiment 4 has been described in conjunction with the case where the flashlight guiding portion 42a is connected to the end surface of the ring portion 42c, the LED light guiding portion 42b may be connected to the end surface instead.

As described above, according to each of Embodiments 1 to 4, the luminous fluxes emitted from the plurality of light sources can emerge from the emergence surface of the common ring portion disposed around the image-taking lens barrel. As a result, it is possible to form the optical system which has a long circumference of the emergence surface, is suitable for illumination for image-taking at a close range (macro photography) requiring the irradiation of uniform luminous flux from the entire circumference of the lens barrel, and is realized by the single system as a whole for use with the plurality of light sources. Thus, the illumination optical system is applicable to an apparatus including a plurality of light sources, not limited to specific types of light sources, for example not only for a continuous light source for taking moving images such as a lamp and an LED, but also for a flashlight source for taking still images such as a xenon discharge tube.

Specifically, according to each of Embodiments 1 to 4, the luminous fluxes emitted from the first and second light sources can emerge from the single emergence portion common to the luminous fluxes from both of the light sources in the optical member. The shape of the emergence portion (the respective surfaces forming the emergence portion) can be optimized to change the luminous fluxes from the first and second light sources with different uses and characteristics into luminous fluxes having predetermined light emission characteristics. In other words, the luminous fluxes from the plurality of light sources can be used selectively to perform desired image-taking without replacing the light-emitting device or changing the mounting position in the image-taking apparatus.

Since the luminous fluxes from the light sources can be guided and gathered only by the combination of refraction and total reflection without using any diffusing surface, the illumination optical system can be achieved highly efficiently.

The optical member can be formed to be extremely thin, thereby enabling design with high space efficiency without significantly increasing the size of the whole apparatus in which the light-emitting device is used.

Since the single optical member can realize all the necessary functions as the member which forms the illumination optical system, the illumination optical system can be provided at extremely low cost.

While each of Embodiments 1 to 4 has been described in conjunction with the case where the flashlight source and the continuous light source are included, the present invention is applicable to an apparatus including a light source with a different use and a different characteristic.

Each of Embodiments 1 to 4 has been described in conjunction with the case where each of the flashlight emitter and the LED light emitter has one light source (such as the xenon discharge tube and the LED). However, the present invention is not limited to the two light sources, and for example, each of the flashlight emitter and the LED light emitter has a plurality of light sources. A lamp may be used as the light source other than the xenon discharge tube and the LED. These light sources may be used in combination.

While each of Embodiments 1 to 4 has been described in conjunction with the light-emitting device which changes the light from the light source provided for the video camera body into the ring light, the light-emitting device may include the light source.

The present invention is not limited to Embodiments 1 to 4 described above and is practiced in various modes. Each of Embodiments 1 to 4 may be carried out with modification as appropriate. In other words, the present invention is not limited to the dimensions, materials, shapes, arrangements and the like of the components described in Embodiments 1 to 4.

The light-emitting device of the present invention may be provided for or removably mounted on various apparatuses such as a digital still camera and a camera-equipped cellular phone, not limited to the video camera described in Embodiments 1 to 4.

This application claims a foreign priority benefit based on Japanese Patent Applications No. 2005-079496, filed on Mar. 18, 2005, which is hereby incorporated by reference herein in its entirety as if fully set forth herein.

What is claimed is:

1. A light-emitting device comprising:
a first light guiding portion which receives first light from a first light source;
a second light guiding portion which receives second light from a second light source; and
an optical member which includes an emergence portion from which the light emerges after it passes each of the first and second light guiding portions.

2. The light-emitting device according to claim 1, wherein the first and second light guiding portions are formed to guide the first light and the second light to substantially the same area or areas adjacent to each other of the emergence portion in a circumferential direction thereof.

3. The light-emitting device according to claim 1, wherein the first and second light guiding portions are formed to guide the first light and the second light to the emergence portion from substantially the same direction in a circumferential direction of the emergence portion.

4. The light-emitting device according to claim 1, wherein the emergence portion has a plurality of reflecting surfaces which reflect and guide the light from the first and second light guiding portions toward an emergence surface of the emergence portion.

5. The light-emitting device according to claim 1, wherein the emergence portion is formed to have a smaller thickness in a direction orthogonal to an emergence surface of the emergence portion away from the first and second light guiding portions in a traveling direction of the light from the first and second light guiding portions.

6. The light-emitting device according to claim 5, wherein the emergence portion is formed in ring shape with its both ends in contact with or close to each other and has a step portion produced by a difference in thickness of the both ends, and
at least one of the first and second light guiding portions guides the light to an area including the step portion or an area adjacent to the step portion in the emergence portion.

7. The light-emitting device according to claim 5, wherein the emergence portion is formed in ring shape with its both ends in contact with or close to each other and has a step portion produced by a difference in thickness of the both ends, and
at least part of the light from the first and second light guiding portions is guided to the emergence portion through the step portion.

8. The light-emitting device according to claim 1, wherein the emergence portion is formed in ring shape, and
the emergence portion is disposed around an image-taking lens.

9. An apparatus which includes a light-emitting device, comprising:
the light-emitting device according to claim 1,
wherein the light-emitting device is removably mounted on or integrally with the apparatus.

10. The apparatus according to claim 9, wherein the apparatus is an image-taking apparatus which takes an image of an object illuminated with light from the light-emitting device.
